(19) United States
(12) Patent Application Publication
(10) Pub. No.: US 2016/0023582 A1
(43) Pub. Date: Jan. 28, 2016

(54) Seat Cover

(71) Applicant: Brian Looper, O'Fallon, MO (US)

(72) Inventor: Brian Looper, O'Fallon, MO (US)

(21) Appl. No.: 14/811,225

(22) Filed: Jul. 28, 2015

Related U.S. Application Data
(60) Provisional application No. 62/029,930, filed on Jul. 28, 2014.

(51) Int. Cl. B60N 2/60

(52) U.S. Cl. CPC B60N 2/6018

(57) ABSTRACT

An easily transportable, machine washable, dryer safe, car seat cover. The device, when not in use, is preferably designed to have the ability to compress to a size generally similar to that of a common softball. The device is also preferably designed to be soft, antimicrobial, water repellant, highly durable, highly stretchable, and lightweight.

### CROSS REFERENCE TO RELATED APPLICATIONS

This application claims benefit of U.S. Provisional Patent Application No. 62/029,930, filed July 28, 2014, the entirety of which is incorporated herein by reference.

### BACKGROUND

1. Field of the Invention

The present disclosure is related to the field of automotive accessories particularly for use with sports equipment and related apparel.

2. Description of the Related Art

Currently there is an increasing emphasis on living healthy lifestyles and a large segment of the population is participating in activities that support such lifestyles. This includes a trend of increased participation in sports and exercise activities. Endurance sports and the training that corresponds to such sports are on the rise as well. Often, this training includes physical activities such as walking, jogging, running, biking, boxing, swimming, etc. These activities are not exclusive to individuals training for a sport but, because they provide great exercise, they are also enjoyed by people with a desire to be healthy.

At the conclusion of almost every exercise session or raining activity, often one thing is common; the participant is “dirty.” Whether it is from biking in a rainstorm, playing ultimate Frisbee' or simply perspiring, the participant is usually wet at the end of the activity and their clothing is usually soaked from sweat.

In order to physically travel to the workout or outdoor activity (gym, trail, pool, beach etc.), the exerciser usually rides in, or drives, a motor vehicle. At the conclusion of the activity the car does not present a problem when there is a place for the activity-goer to change clothing, such as a gym locker room. Because people have a desire to be dry, especially while driving, the car presents an issue if, for instance, a person has just finished a long bike ride in a public park and does not desire to change into dry clothes in the “privacy” of a public parking area. Also, changing post exercise is wasteful in that two sets of clothing are now “dirtied” because it is common for a person to change into yet another set of clothing after bathing. In addition to the inherent desire to be dry, people do not wish to sit on a car seat soaked from a workout, which leads to a person constructively sitting in a puddle of their own sweat.

Cars have evolved from horseless carriages with wooden bench seats into the leather wrapped luxurious highway cruisers of today. The car seat of today typically is comprised of a few components: base/seat portion, a backrest portion which sometimes has side bolsters extending therefrom, and a headrest, also known as a head restraint, located above the backrest.

The upholstery of car seats of today is typically comprised of materials such as cloth, vinyl, and leather. Almost all of today's car seats share a common characteristic: the material from which they are made has the ability to absorb not only liquid but also scents, dirt, grime, grease, and other contaminants.

A soaked exerciser using a car seat usually expels both a scent of body odor and liquid from sweat onto the car seat. This is problematic in that the car is usually used for more than just a method of transportation to and from a workout; that same seat could be used by someone wearing formal attire later that same day, and it is likely that the stench or liquid from an earlier workout could make its way onto other garments. It would be highly unlikely that such a transfer to other garments would be desired. A seat saturated from sweat, or any liquid, could take hours to dry, especially in colder temperatures. In warmer temperatures, drying could occur more easily but such sweat could permeate the absorbent materials of the automobile interior, such as the seat and headliner, thereby damaging the car. There are usually two post workout options presented to an exerciser who does not change clothes but wants to keep their car seats from being the equivalent of a repository of scents and fluids: disrobing, drying off with a towel, and then sitting in the car; or putting a barrier between themselves and the seat.

There are currently some barrier products available to prevent an exerciser from soiling a car seat. These devices, commonly known as seat covers, are often custom tailored to the specifications of the specific seat of a particular vehicle. U.S. Pat. No. 5,806,925, the entire disclosure of which is herein incorporated by reference, provides an example of a seat cover that provides protection to the car's seat; however, it takes a relatively long time to install because the fasteners used to secure the seat cover to the car seat require multiple steps for proper installation. Some car seat covers commonly engulf the entire seat surfaces and secure to the bottom surface of the seat portion either through compression fit or additional fasteners located underneath the seat. Often the fasteners underneath the seat render seat adjustments inoperable due to their impediment of the seat tracks. Because seat covers fit tightly onto the seat, these seat covers are manufactured with tight tolerances to ensure they fit snugly. In addition, seat covers such as these are not usually intended to be removable or machine washable because the materials from which they are usually manufactured and the fasteners employed are not designed to withstand a washing machine. Therefore, some of the same problems important to individuals with an active lifestyle still exist; the exerciser can introduce unwanted smells and liquids to a car seat cover that might later be used when the exerciser is using the car for a different purpose due to the time required for installation and it not being machine washable.

Other devices, such as a beach towel car seat cover, as disclosed in U.S. Pat. No. 7,000,984 B1, the entire disclosure of which is herein incorporated by reference, attaches on top of a car seat and is held in place with a series of straps and various fasteners located on the rear of the backrest of the seat. This device is not ideal for easy transportation, something that is desired by an exerciser with an active lifestyle. For example, this device, when not in use, is not easily storable as it does not compress to a smaller size; the device is simply folded like a garment and transported like one would transport a traditional beach towel. In fact, this device even doubles as a beach towel. As such, when not in use this device could occupy too much space in a gym bag or car trunk. If, for instance, a bike rider would need to carry this device with them on a bike ride, it would be cumbersome without a sufficiently large storage compartment.

Another commercially available device, sold by the company Towelmate as “Car Seat Cover”, gives partial coverage of a car seat and can fold into a storage receptacle rigidly attached to the support frame of a car seat's headrest when not in use. This device is not a viable solution for every car as a large number of car headrests do not have such supports or clearances. Some car seats, like the seats standard on a 1990-2002 Mercedes SL (129 Chassis), do not have such support rails for the headrests; the headrests are secured to the seat via a side mounted pillar internal to the seat. In addition, the partial coverage provided h this device does not extend to the side bolsters of the seat, an area which receives a fair amount of wear and tear, especially during cornering or when entering and exiting the vehicle. As such, fluids are capable of impregnating the material of the bolsters. In addition, this device has the potential of affecting the operation of certain vehicle equipment, such as neck protection systems, due to their integration with the supports of the headrests. Neck protection systems allow the headrest to move forward in the event of a collision thereby providing a restraint for an occupant's head. Such systems are standard equipment in a variety of late model vehicles.

There currently exists a need in the market for a product which provides more than partial coverage of a seat, is easy for a user to quickly fit to a variety of car seats, has a waterproof layer, an absorbent layer, and can be greatly compacted so as to be easily transportable.

### SUMMARY

The following is a summary of the invention which should provide to the reader a basic understanding of some aspects of the invention. This summary is not intended to identify critical components of the invention, nor in any way to delineate the scope of the invention. The sole purpose of this summary is to present in simplified language some aspects of the invention as a prelude to the more detailed description presented below.

Because of these and other problems in the art, described herein, among other things, is a car seat cover, comprising: a main body having an absorbent layer and an impermeable layer joined together, the main body having a top end; and a pocket constructed from a stretchable fabric and having an interior volume attached to the top end of the impermeable layer of the main body; wherein the main body when placed on a car seat extends across substantially an entire seating surface and a backrest surface of the car seat; and wherein the pocket is configured to at least partially engulf a headrest of a car seat.

In an embodiment, the impermeable layer of the main body further comprises: a securing band attached thereto configured to secure the main body to the backrest of a car seat so the impermeable layer is in contact with the seating surface of a car seat.

In an alternative embodiment, the absorbent layer is about 220 g/m².

In a further embodiment, the absorbent layer is constructed from polyester velour.

In a still further embodiment, the absorbent layer further comprises of an antimicrobial component.

In a still further embodiment, the impermeable layer is constructed from thermal polyurethane.

In a still further embodiment, the thickness of the thermal polyurethane is 0.02 mm.

In a still further embodiment, a third layer is attached to the impermeable layer; and the third layer comprises a soft absorbent material.

In a still further embodiment, the third layer is polyester velour.

In a still further embodiment, the absorbent layer and the impermeable layer are joined together by sewing.

In a still further embodiment, the absorbent layer and the impermeable layer are joined. together by bonding.

### BRIEF DESCRIPTION OF THE DRAWINGS

FIG. 1 provides a perspective view of an embodiment of the seat cover overlaid on an existing seat.

FIG. 2 provides an underside perspective view of an embodiment of the seat cover in the extended position.

FIG. 3 provides a side perspective view of an embodiment of the seat cover in the extended position.

FIG. 4 provides a side prospective cut-away view of the car seat cover in the extended position.

FIG. 5 provides rear perspective view of a car seat with an embodiment of the car seat cover overlaid on an existing seat.

FIG. 6 provides a front perspective view of an embodiment of the seat cover overlaid on an existing seat.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and apparatus. As various changes could be made in the above constructions without departing from the scope of the disclosures, it is intended that all matter contained in the above description or shown in the accompanying drawings shall be interpreted as illustrative and not in a limiting sense.

Described herein, among other things, is an easily transportable, machine washable, dryer safe, car seat cover. The device, when not in use, is preferably designed to have the ability to compress to a size generally to that of a common softball. The device is also preferably designed to be soft, anti microbial, water repellant, highly durable, highly stretchable, and lightweight.

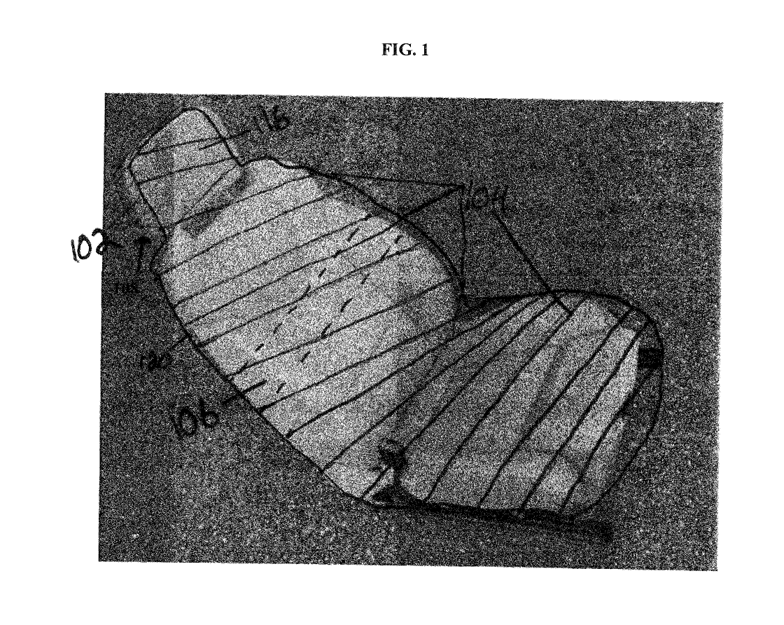

FIG. 1 depicts an embodiment of the seat cover (101). In the depicted embodiment of FIG. 1, the seat cover device comprises: a pocket (102), which is configured to be fitted at least partially over the headrest (107) of a car seat (103), a main body (104) which extends down from the front (116) of the pocket (102), and an elastic, or similar, securing band (106). The main body (104) is of sufficient dimensions to cover at least the portion of the backrest (120) which is in contact with the seat's (103) occupant and also cover the seat portion (105) which would be in contact with the occupant of the car seat (103). In an embodiment, the length of the main body (104) ranges from 36 inches to 60 inches and is preferably about 45.5 inches.

To help secure the car seat cover (101) to the car seat (103) a securing band (106) is used in some embodiments. The securing band (106) secures the main body (104) of the car seat cover (101) over the seat (103). The securing band (106), in a particular embodiment, is constructed from elastic or similar material and is around 16 inches to 28 inches in length, and is preferably 22 inches in length when not stretched; the width of the securing band (106) is around 1 inch to 4 inches, and is preferably about 1.96 inches in width.

A car's headrest (107) usually has six external sides: top, bottom, front, back, left, and right. Headrests (107) are usually structurally secured to the backrest (120) of a seat (103) by two posts which enable the headrest (107) to be vertically adjustable relative to the backrest (120). The pocket (102) of the current disclosure is configured to at least partially enclose or generally engulf at least five sides of a car's headrest (107) (front, back, top, left, and right), and also partially enclose the bottom side (the side which is parallel with the top surface of the back rest of the car seat). The main body (104) of the car seat cover (101) extends from the front portion (116) of the pocket (102) downwards towards the seat portion (105) of the car seat (103) and is of sufficient length and width to cover both the portions of the backrest (120) and seat (105) of the car seat (103) which would be in contact with an occupant. In an embodiment, the main body (104) is of a length and width which extends past the dimensions of a car seat (103) and drapes over the sides (109) of the seat portion (105). The portion of the seat cover (101) which is connected to the pocket (102) extends out from the pocket (102) portion to the width of main body (104) and optionally further comprises elastic straps to secure the main body (104) to the top corners of the backrest (120) of the car seat (101).

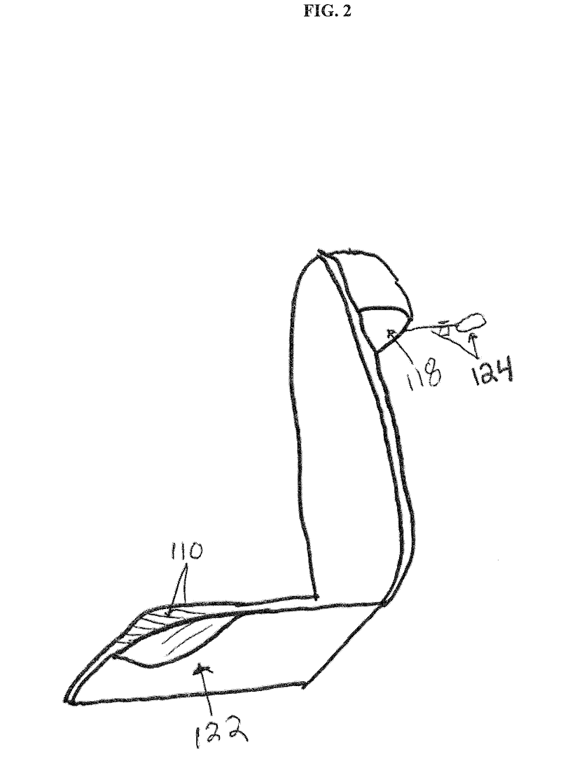

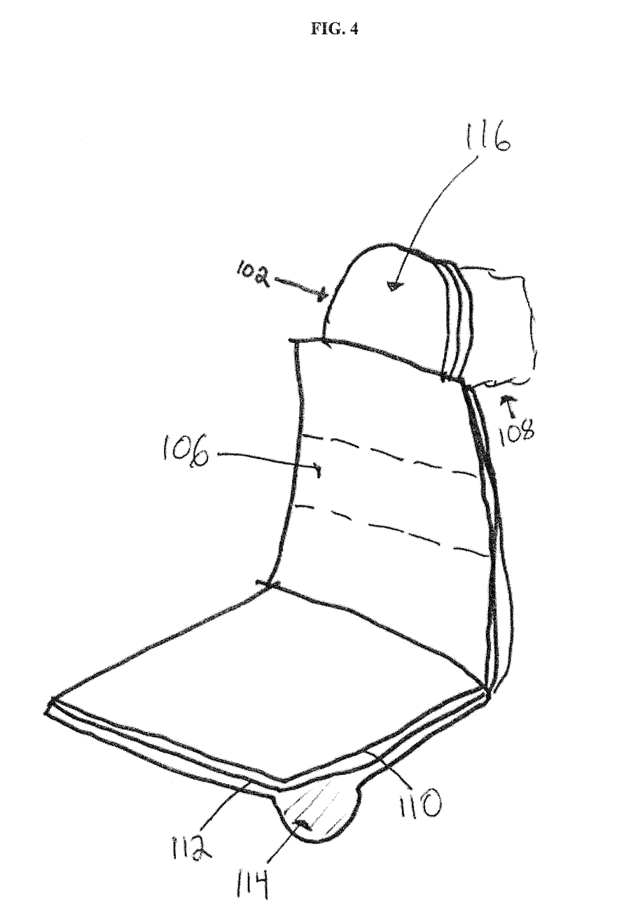

The material used to construct the main body (104) and the pocket (102), in a particular embodiment, is identical and is comprised of multiple layers of differing composition. In another embodiment, only the front sides (116) of the pocket (102) which would be in contact with the occupant of the seat (103) are constructed from the same material as the main body (104). The other sides of the pocket (102), which partially engulf a headrest (107), are constructed from spandex or similar material. In one embodiment, such as that depicted in FIG. 2, the material used throughout the car seat cover (101) is composed of two individual attached layers (110) and (112). The first layer (110) is an absorbent layer (110) of a polyester velour (preferably 100% polyester) or similar material, which has the ability to absorb liquid. In some embodiments the absorbent layer (110) contains an antimicrobial component. In a particular embodiment, the layers (110) and (112) are attached to each other by being bonded together. The second layer (112) is an impermeable layer (112) which generally is impermeable to liquids (but such is not required) and in some embodiments, the side of the impermeable layer (112) which is in contact with the car seat (103) contains non-slip components so as to increase friction between the seat's (103) upholstery and the exterior of the impermeable layer (122). In a particular embodiment, the impermeable layer (112) is composed from thermal polyurethane. In yet another embodiment, such as that depicted in FIG. 4, the material further comprises a third layer (114) composed from the same material as the absorbent layer (110). In this embodiment, the impermeable layer (112) is preferably situated between the absorbent layer (110) and the third layer (114), i.e. the impermeable layer (112) is surrounded by the other layers (110) and (114).

The material from which the pocket (102) and main body (104) are composed may be varying thickness and weight. In one embodiment, the thickness of the generally impermeable layer (112) ranges from 0.01 mm to 0.1 mm and is preferably about 0.02 mm. The absorbent layer (110) is of a thickness ranging from 100 g/m² to 400 g/m² and is preferably around 220 g/m². The combined total weight of the layers is preferably about 260 g/m²±5%.

In an embodiment, the absorbent layer (110) and impermeable layer (112) are attached to each other via traditional sewing, at least on the perimeter of the main body (104) and where the main body (104) meets the pocket (102). In some embodiments, the perimeter of both the main body (104) and the pocket (102) will have a seam (111) constructed from nylon or similar material.

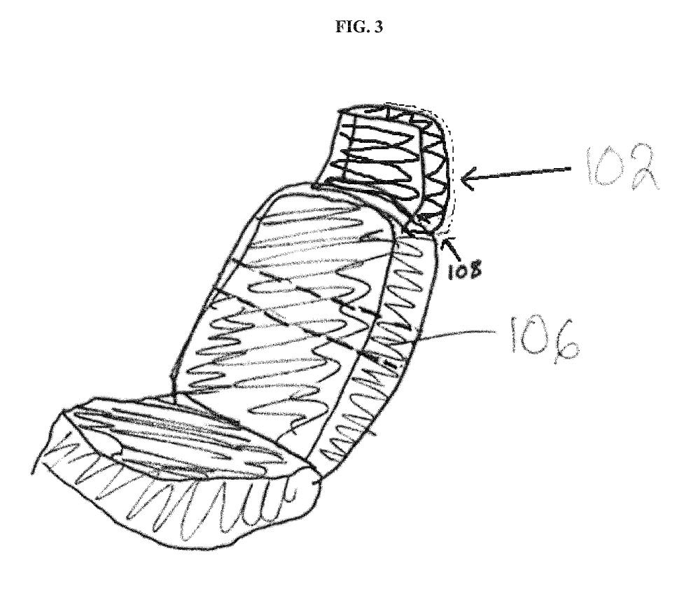

Space is often an important commodity in bags, trunks, glove boxes and various other storage compartments. This is especially true for individuals who live an active sporting lifestyle as space in a gym bag can come at a premium. Because of this, an embodiment of the present disclosure, such as that depicted in FIG. 3, is preferably designed so the main body (104) can be stored within the interior (108) of the pocket (102) for transportation and storage. The pocket (102) is configured so that the entirety of the seat cover (101) elements can be stored within (108) the pocket (102) itself, i.e. the portion which surrounds the headrest (107) can house the main body (104) for storage. When the main body (104) is stored within the interior (108) of the pocket (102), the pocket (102) can compress to about the size of a common softball, about 12 inches in circumference. In a particular embodiment, such as that depicted in FIG, 2, the pocket (102) is made from spandex or similar material with a drawstring (124) within the perimeter of the spandex material and extending through the portion of the pocket (102) which is made from the same material as the main body (104).

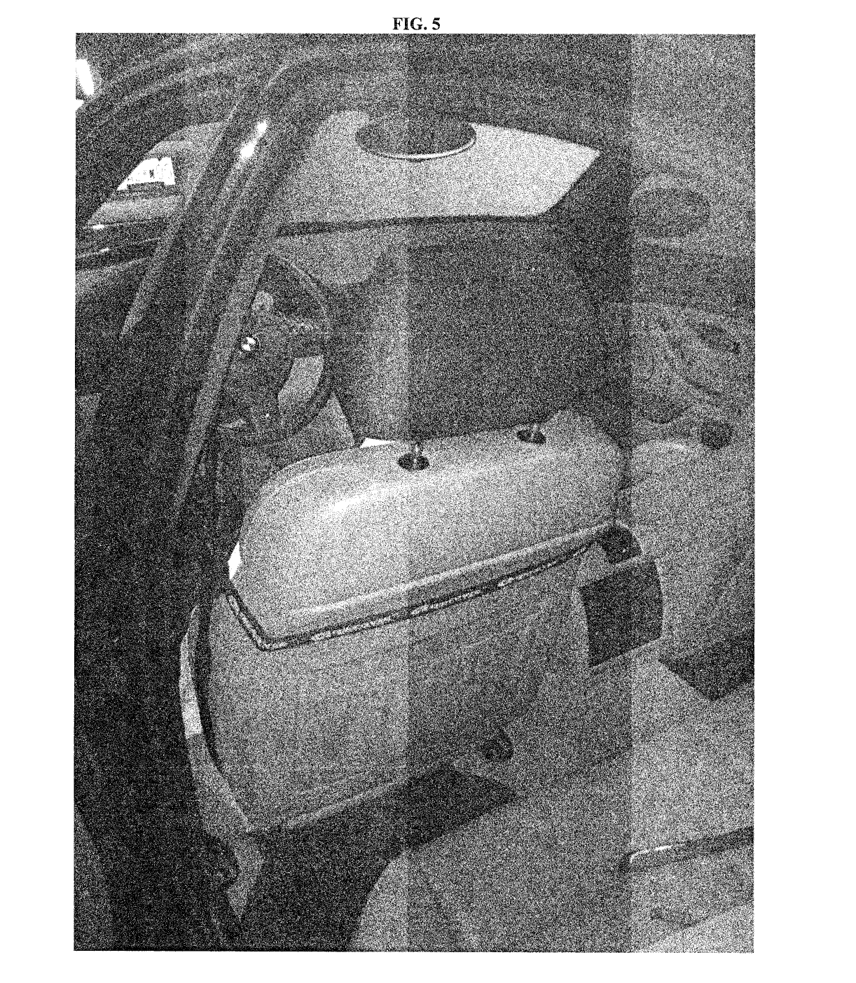

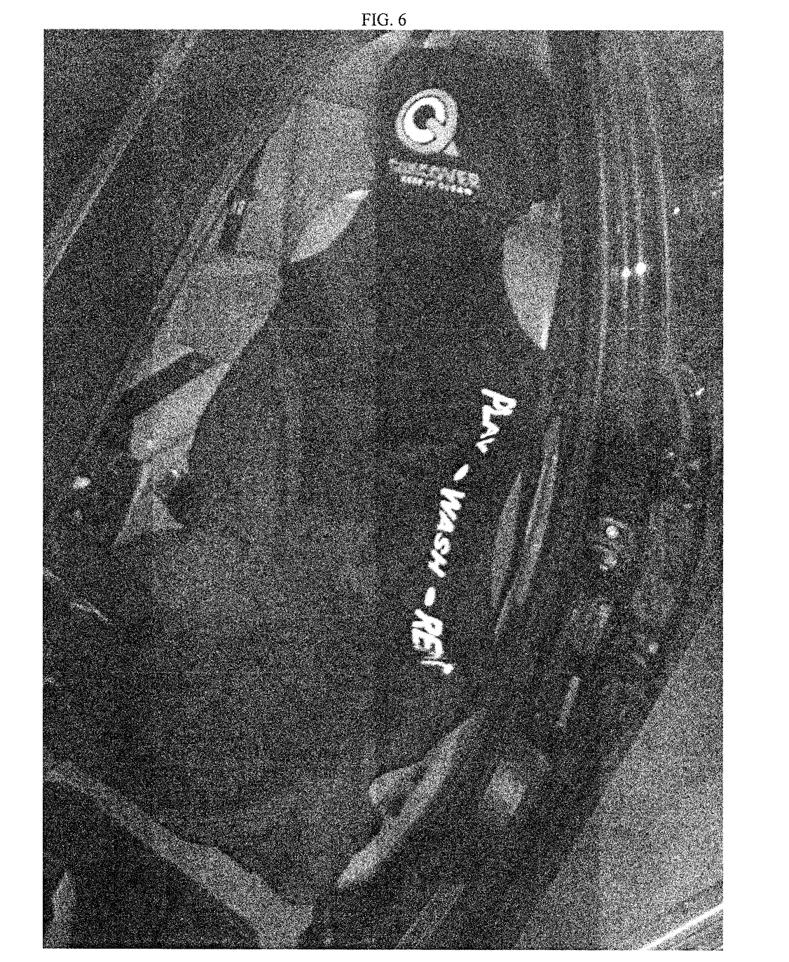

In operation, one uses the seat cover (101) in a normal manner by stretching the pocket (102) around a car seat's (103) headrest (107) so as to generally engulf the headrest (107). FIG. 6 depicts an embodiment of a cover (101) installed in a vehicle. The main body (104), which extends from the bottom of the pocket (102), is then placed over the seating surfaces of the car seat (103) and any excess fabric of the main body (104) is draped over the sides of the car seat. In some embodiments, such as that depicted in FIG. 5, the user also slides the securing band (106) around the back of the car seat (103) so as to securely position the seat cover (101) to the car seat (103). Also, in some embodiments, the perimeter of the main body (104) is configured to be similar to a fitted sheet of a mattress whereby there is a taper which provides a more fitted cover. When the user removes the seat cover (101) from the car seat (103), the main body (104) is folded or simply scrunched up and stuffed into the pocket (102). The user then tightens the drawstring (124) and the pocket (102) has been reduced to a desired size.

In a particular embodiment, the pocket (102) is produced from spandex or equivalent stretchable fabric and is attached to the back of the top of the main body (104), the main body (104) thereby making up the fifth side of the pocket (102).

While the device has been described in great detail, further objects and advantages will become apparent from a study of the following accompanying figures.

While the inventions have been disclosed in connection with certain preferred embodiments, this should not be taken as a limitation to all of the provided details of any invention. Modifications and variations of the described embodiments may be made without departing from the spirit and scope of any invention herein disclosed, and other embodiments should be understood to be encompassed in the present disclosure as would be understood by those of ordinary skill in the art.

1. A car seat cover, comprising:
a main body having an absorbent layer and an impermeable layer joined together, the main body having a top end; and
a pocket constructed from a stretchable fabric and having an interior volume attached to said top end of said impermeable layer of said main body;
wherein said main body when placed on a car seat extends across substantially an entire seating surface and a backrest surface of said car seat; and
wherein said pocket is configured to at least partially engulf a headrest of a our seat.

2. The car seat cover of claim 1, wherein said impermeable layer of the main body further comprises:
a securing band attached thereto configured to secure said main body to the backrest of a car seat so said impermeable layer is in contact with the seating surface of a car seat.

3. The car seat cover of claim 1, wherein said absorbent layer is about 220 g/m².

4. The car seat cover of claim 1, wherein said absorbent layer is constructed from polyester velour.

5. The car seat cover of claim 1, wherein said absorbent layer further comprises of an antimicrobial component.

6. The car seat cover of claim 1, wherein said impermeable layer is constructed from thermal polyurethane.

7. The car seat cover of claim 6, wherein the thickness of said thermal polyurethane is 0.02 mm.

8. The car seat cover of claim 1, wherein a third layer is attached to said impermeable layer;
and wherein said third layer comprises a soft absorbent material.

9. The car seat cover of claim 8, wherein said third layer is polyester velour.

10. The car seat cover of claim 1, wherein the absorbent layer and the impermeable layer are joined together by sewing.

11. The car seat cover of claim 1, wherein the absorbent layer and the impermeable layer are joined together by bonding.
